(19) United States
(12) Patent Application Publication
(10) Pub. No.: US 2012/0127155 A1
(43) Pub. Date: May 24, 2012

(54) 3D COMFORT AND FUSION LIMIT EMPIRICAL MODEL

(75) Inventor: Sachin G. Deshpande, Camas, WA (US)

(73) Assignee: SHARP LABORATORIES OF AMERICA, INC., Camas, WA (US)

(21) Appl. No.: 12/953,297

(22) Filed: Nov. 23, 2010

(51) Int. Cl. G06T 15/00

(52) U.S. Cl. 345/419

(57) ABSTRACT

A method for displaying a pair of stereoscopic images on a display includes receiving a pair of images forming the pair of stereoscopic images, one being a left image and one being a right image. The disparity is adjusted between the left image and the right image based upon a profile of a particular viewer.

### CROSS-REFERENCE TO RELATED APPLICATIONS

Not applicable.

### BACKGROUND OF THE INVENTION

The present invention relates generally to displaying stereoscopic images on a display.

Viewing stereoscopic content on planar stereoscopic display sometimes triggers unpleasant feelings of discomfort or fatigue in the viewer. The discomfort and fatigue may be, at least in part, caused by limitations of existing planar stereoscopic displays. A planar stereoscopic display, no matter whether LCD based or projection based, shows two images with disparity between them on the same planar surface. By temporal and/or spatial multiplexing the stereoscopic images, the display results in the left eye seeing one of the stereoscopic images and the right eye seeing the other one of the stereoscopic images. It is the disparity of the two images that results in viewers feeling that they are viewing three dimensional scenes with depth information. This viewing mechanism is different from how eyes normally perceive natural three dimensional scenes, and may causes a vergence-accommodation conflict. The vergence-accommodation conflict strains the eye muscle and sends confusing signals to the brain, and eventually cause discomfort/fatigue.

The preferred solution is to construct a volumetric three dimensional display to replace existing planar stereoscopic displays. Unfortunately, it is difficult to construct such a volumetric display, and likewise difficult to control such a display.

Another solution, at least in part, is based upon signal processing. The signal processing manipulates the stereoscopic image pair sent to the planar stereoscopic display in some manner. Although the signal processing cannot fundamentally completely solve the problem, the vergence-accommodation conflict can be significantly reduced and thereby reduce the likelihood of discomfort and/or fatigue.

What is desired is a display system that reduces the discomfort and/or fatigue for stereoscopic images.

The foregoing and other objectives, features, and advantages of the invention will be more readily understood upon consideration of the following detailed description of the invention, taken in conjunction with the accompanying drawings.

### BRIEF DESCRIPTION OF THE SEVERAL VIEWS OF THE DRAWINGS

FIG. 1 illustrates a stereoscopic viewing system for reducing discomfort and/or fatigue.

FIG. 2 illustrates a three dimensional mapping.

FIG. 3 illustrates disparity estimation.

FIGS. 4A-4C illustrate a masking technique.

FIG. 5 illustrates a function for mapping.

FIG. 6 illustrates percival's zone of comfort.

FIG. 7 illustrates focal distance versus vergence distance.

FIG. 8 illustrates Percival Zone of Comfort Disparity versus Viewing distance for negative disparity.

FIG. 9 illustrates Percival Zone of Comfort Disparity versus Viewing distance for positive disparity.

FIG. 10 illustrates comfort scale versus disparity for negative disparity for a first set of images.

FIG. 11 illustrates comfort scale versus disparity for positive disparity for a first set of images.

FIG. 12 illustrates comfort scale versus disparity for negative disparity for a second set of images.

FIG. 13 illustrates comfort scale versus disparity for positive disparity for a second set of images.

FIG. 14 illustrates comfort scale versus disparity for negative disparity for a third set of images.

FIG. 15 illustrates comfort scale versus disparity for positive disparity for a third set of images.

FIG. 16 illustrates comfort scale versus disparity for negative disparity for the average of the three sets of images.

FIG. 17 illustrates comfort scale versus disparity for positive disparity for the average of the three set of images.

FIG. 18 illustrates fusion area boundaries.

FIG. 19 illustrates 3D fusion limit versus test images for negative disparity.

FIG. 20 illustrates 3D fusion limit versus test images for positive disparity.

FIG. 21 illustrates synthesis of a new image.

FIGS. 22A-22C illustrates image occlusion.

FIG. 23 illustrates missing pixel filling.

### DETAILED DESCRIPTION OF PREFERRED EMBODIMENT

The system provides a signal processing based technique to reduce the discomfort/fatigue associated with 3D viewing experience. More specifically, given a planar stereoscopic display, the technique takes in a stereoscopic image pair that may cause viewing discomfort/fatigue, and outputs a modified stereoscopic pair that causes less or no viewing discomfort/fatigue.

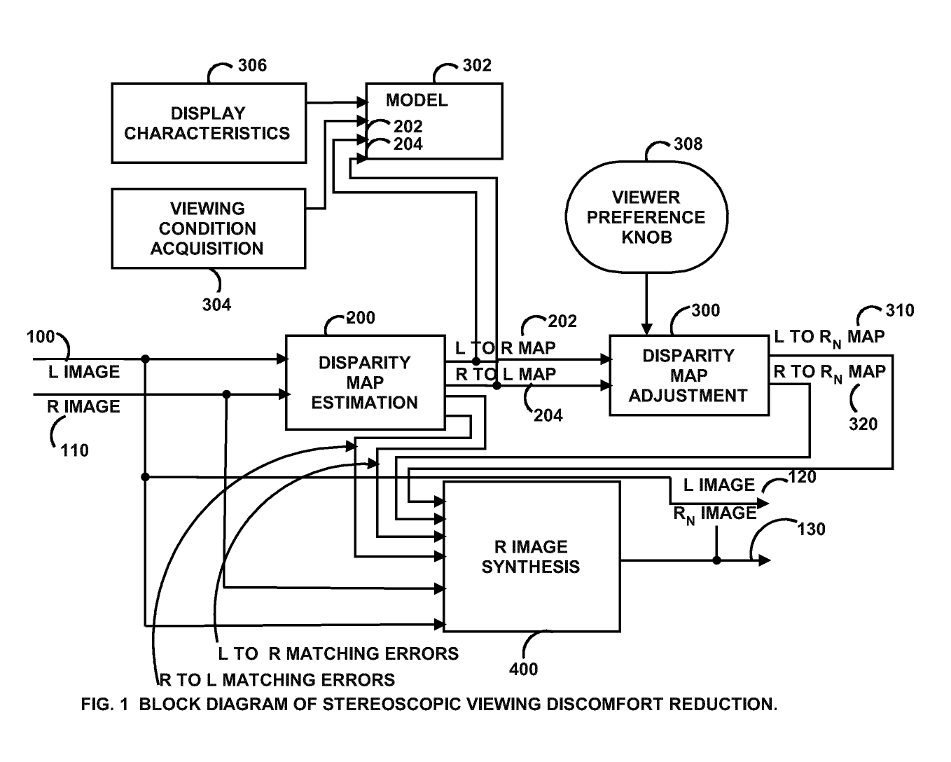

A stereoscopic processing system for reducing viewer discomfort is illustrated in FIG. 1. This technique receives a stereoscopic pair of images 100, 110, in which one image 100 is for the left eye to view (L image) and the other image is for the right eye to view (R image) 110, and outputs a modified stereoscopic pair of images 120, 130, in which L image 120 is preferably unchanged, and R image 130 is a synthesized one (R_{N} image). If the input stereoscopic image pairs have very large disparities in some areas between two images, the large disparities may cause severe vergence-accommodation conflict that leads to discomfort or even fatigue for some viewers.

As shown in FIG. 1, the technique may include three major components, namely, a disparity map estimation 200, a disparity map adjustment 300, and a R image synthesis 400. For simplicity, the system may presume that the input stereoscopic pair has been rectified so the disparity between two images is only horizontal. In other cases, the system may presume and modify accordingly where the input stereoscopic pair is rectified in any other direction or otherwise not rectified.

The disparity map estimation 200 outputs two disparity maps, LtoR map 202 and RtoL map 204. The LtoR map 202 gives disparity of each pixel in the L image, while the RtoL map 204 gives disparity of each pixel in the R image. The data also tends to indicate occlusion regions. The disparity map estimation 200 also provides matching errors of the two disparity maps, which provides a measure of confidence in the map data.

The adjustment of the LtoR map 202 and the RtoL map 204 in the disparity map adjustment 300 are controlled by a pair of inputs. A discomfort model 302 may predict the discomfort based upon the estimated disparity in the image pairs 202, 204, viewing conditions 304, display characteristics 306, and/or viewer preferences 308. Based upon this estimation the amount of disparity may be modified. The modification may result in global modification, object based modification, region based modification, or otherwise. A modified set of disparity maps 310, 320 are created.

The R image synthesis 400 synthesizes a R image 130 based upon data from the disparity map adjustment 300, the disparity map estimation 200, and input image pair 100, 110. The preferred implementation of the disparity map estimation 200, disparity map adjustment 300 and R image synthesis 400 are described below.

The disparity map estimation 200 inputs the image pairs, L image 100 and R image 110, and outputs two disparity maps, the LtoR 202 map and the RtoL 204 map. The LtoR disparity map 202 contains disparities of every pixel (or selected pixels) in the L image 100, and the RtoL map 204 contains disparities of every pixel (or selected pixels) in the R image 110. The technique for generating LtoR map 202 and RtoL map 204 are preferably functionally the same. For the convenience of the discussion, the generation of LtoR disparity map is illustrated as an example, while the RtoL map is generated similarly.

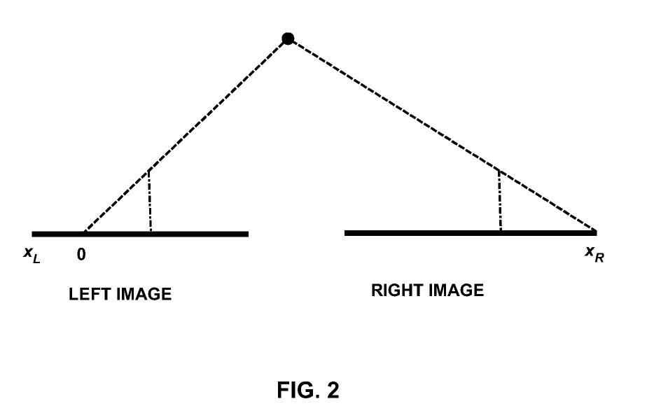

When generating the LtoR disparity map 202, the disparity map estimation 200 primarily performs the following functionality, given a stereoscopic image pair that has been properly rectified, for any pixel position in x_{L} the left image that is corresponding to a three dimensional point in the real or virtual world, to find the pixel position x_{R} in the right image that is corresponding to the same three dimensional point. The horizontal difference between corresponding pixel positions in the left and right images, x_{R}-x_{L}, is referred to as a disparity, such as illustrated in FIG. 2. Because the stereoscopic image pair has been rectified, the search for the corresponding pixels need only be done in one dimension and only along the horizontal lines. With different or no rectification, the search is performed in other directions.

Disparity estimation may be characterized as an optimization for finding suitable disparity vector(s) that minimizes, or otherwise reduce, a pre-defined cost function. A disparity estimation approach may generally be classified into one of three different categories: (1) estimating a single disparity vector, (2) estimating disparity vectors of a horizontal line, or (3) estimating disparity vectors of entire image.

Using a disparity estimation based upon a single disparity vector results in a cost function where there is only one disparity vector to optimize, and as a result, optimization only yields one disparity vector of the interested pixel/window/block/region. In order to get dense disparity vector map of the resolution of m×n, as many as m×n number of cost functions are constructed and optimized. A couple suitable techniques include block matching and Lucas-Kanade.

Using a disparity estimation based upon a horizontal line results in a cost function where disparity vectors of a horizontal line are optimized simultaneously. In order to get a sufficiently dense disparity vector map of the resolution of m×n, only m cost functions are constructed, and each cost function yields n disparity vectors. The optimization of the cost function is somewhat complex and is typically done by dynamic programming.

Using a disparity estimation based upon the entire image results in a cost function where all disparity vectors of the entire image are used as part of the optimization. Therefore, to get a dense disparity vector map with the resolution of m×n, only one cost function is constructed, and this cost function yields m×n disparity vectors simultaneously. The optimization of the cost function is the most computationally complex of the three and is typically done by a global optimization method called min-cut/max-flow.

With real-time disparity estimation determined using limited computational resources, the preferred disparity estimation technique is based upon a single disparity vector. This reduces the computational complexity, albeit with typically somewhat less robustness and increased noise in the resulting image.

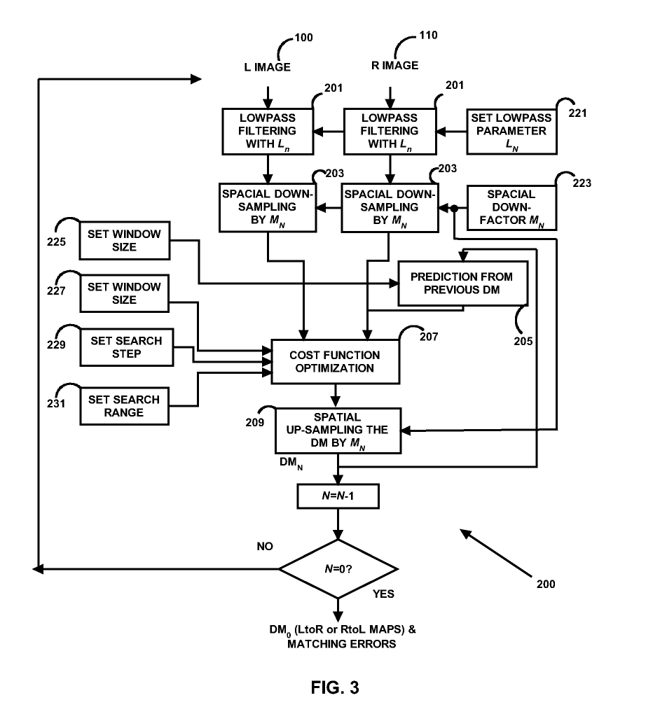

An exemplary disparity map estimation 200 is illustrated in FIG. 3. Its cost function is constructed based on a regularized blocking matching technique. Regularized block matching may be constructed as an extension to basic block matching. The cost function of a basic block matching technique may be the summed pixel difference between two blocks/windows from the left and the right images, respectively. The cost function of position xₒ in the left image may be defined as:

$${ME}_{{x}_{0}} ( DV ) = \frac{1}{N} {\sum }_{x ∈ {WCx}_{0}} ( D ( x , x + DV ) )$$

where WCx₀ is the window centered at x₀ in L image, and D(x, x+DV) is the single pixel difference between the pixel at x in L image and the pixel at x+DV in R image. To increase the robustness, the cost function may use the sum of pixel differences between the window centered at x₀ in the left image and the window centered at x₀+DV in the right image. The equation above using pixel differences alone may not be sufficient for finding true disparities. Preferably, the global minimum of the cost function in the search range corresponds to the true disparity, but for many natural stereoscopic image pairs, the global minimum is not always corresponding to the true disparity, due to lack of texture and/or repetitive patterns, etc.

Regularized blocking matching techniques may include a regularization term P in the equation of a basic block matching to explore the spatial correlation (or other correlation measure) in neighboring disparities. Specifically, the cost function then may become:

$${ME}_{{x}_{0}} ( DV ) = \frac{1}{N} {\sum }_{x ∈ {Wx}_{0}} ( D ( x , x + DV ) ) + λ P$$

where λ controls the strength of the regularization term P. P is preferably designed to favor a disparity vector DV that is similar to its neighboring disparity vectors, and to penalize DV that is very different from its neighboring disparity vectors. Due to the regularization term, the modified cost function does not always select the disparity vector that minimizes the pixel matching difference, but selects one that both minimizes the pixel matching difference, and is also close to the neighboring motion vector(s).

The preferred modified regularized block matching increases the effectiveness of a regularized block matching technique. Factors that may be used to increase the effectiveness include, (1) disparity vectors of neighboring pixels are highly correlated (if not exactly the same), and (2) estimation errors by the basic block matching cost function are generally sparse and not clustered.

The preferred cost function used in the disparity estimation 200 is:

$${ME}_{{x}_{0}} ( DV ) = {\sum }_{x ∈ {WCx}_{0}} ( D ( x , x + DV ) {Msk}_{C} ( x ) ) / {\sum }_{x ∈ {WCx}_{0}} ( {Msk}_{C} ( x ) ) + λ P ( DV - {DV}_{p} )$$

This modified cost function is in the form of regularized blocking matching. The first term relates to how similar/different between x₀ in the left image and x₀+DV in the right image in terms of RGB pixel values, while the second term relates to how different DV is different from its prediction.

In traditional block matching techniques, all the pixel differences D(x, x+DV) are used in the summation. Using all pixels in the summation implicitly assumes that all these pixels have the same disparity vector. When the window is small, the pixels in the window typically belong to the same object, and this assumption is acceptable. However, when the window is big, this assumption is not acceptable. The larger window may contain several objects with different disparities.

In contrast, in the modified technique, not all single pixel difference D(x, x+DV) in WCx₀ are used in the summation. Only some of them are selected in the summation. The selection may be controlled by a binary Msk_{C}(x). Only those pixels whose RGB values are sufficiently similar to the center pixel's RGB value (or other value) in the left image are included in the summation, because these pixels and the center pixel likely belong to the same object and therefore likely have the same disparity.

The difference between every pixel in the window (or selected pixels) in the left image and the central pixel (or selected pixel) in that window is calculated, if the difference is smaller than a threshold S_{C}, then Msk_{C}(x) of this pixel is 1 and this pixel is selected; otherwise Msk_{C}(x) of this pixel is 0 and this pixel is not selected. Mathematically, Msk_{C}(x) is represented as:

$${Msk}_{c} ( x ) = \{ \begin{matrix}1 & \vert {R}_{L} ( x ) - {R}_{L} ( {x}_{0} ) \vert < {S}_{C} \& \vert {G}_{L} ( x ) - {G}_{L} ( {x}_{0} ) \vert < {S}_{C} \& \vert {B}_{L} ( x ) - {B}_{L} ( {x}_{0} ) \vert < {S}_{C} \\ 0 & otherwise\end{matrix}$$

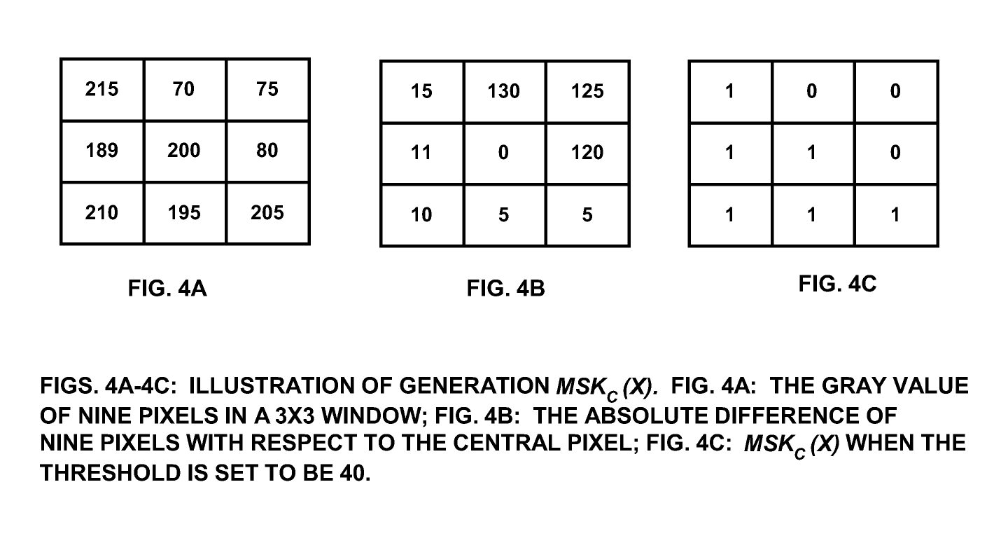

This selection by Msk_{c}(x) is illustrated in FIG. 4 using an example, which has only gray values not RGB values (for purposes of illustration). FIG. 4A illustrates a set of pixel values. FIG. 4B illustrates the difference between the pixels with respect to the center pixel. This provides a measure a uniformity. FIG. 4C illustrates thresholding of the values, such as a value of 40. This permits removal of the values that are not sufficiently similar, so a better cost function may be determined. There are many ways to calculate the single pixel difference D(x, x+DV). The following embodiment is the preferred technique:

D(x,x+DV)=|R_{L}(x)−R_{R}(x+DV)|+|G_{L}(x)−G_{R}(x+DV)|+|B_{L}(x)−B_{R}(x+DV)|

where R_{L}(x), G_{L}(x) and B_{L}(x) are the RGB values at position x in the left image, and R_{R}(x), G_{R}(x) and B_{R}(x) are the RGB values at position x in the right image.

The second term λP(DV−DVₚ) is the regularization term that introduces the spatial consistency in the neighboring disparity vectors. The input is the difference between DV and predicted DVₚ. This regularization term penalizes bigger difference from the prediction where parameter λ controls its contribution to the entire cost function.

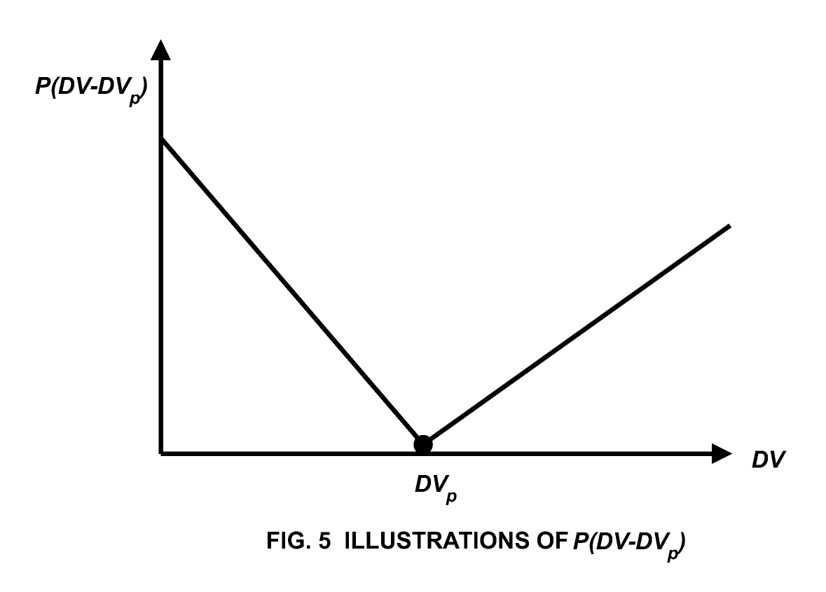

One embodiment of P(DV−DVₚ) used in the preferred technique is P(DV−DVₚ)=|DV−DVₚ| which is illustrated in FIG. 5. The prediction DVₚ not only serves as the initialization of the search, but also regularizes the search. The prediction DVₚ may be calculated by the following equation:

$${DV}_{p} = {\sum }_{x ∈ {WDx}_{0}} ( DV ( x ) {Msk}_{D} ( x ) ) / {\sum }_{x ∈ {WDx}_{0}} ( {Msk}_{D} ( x ) )$$

where WDx₀ is the window for prediction. Although WDx₀ is centered at position x₀, same as WCx₀, WDx₀ and WCx₀ are two different windows. Typically, WDxₒ should be much bigger than WCx₀. Msk_{D}(x) may be defined as:

$${Msk}_{D} ( x ) = \{ \begin{matrix}1 & \begin{matrix}\vert {R}_{L} ( x ) - {R}_{L} ( {x}_{0} ) \vert < {S}_{D} \& \vert {G}_{L} ( x ) - {G}_{L} ( {x}_{0} ) \vert < {S}_{D} \\ \& \vert {B}_{L} ( x ) - {B}_{L} ( {x}_{0} ) \vert < {S}_{D}\end{matrix} \\ 0 & otherwise\end{matrix}$$

where Msk_{D}(x) selects pixels whose estimated disparity vectors are used in the averaging.

Traditionally there is no prediction done in a very small window, such as 3×3. Because the prediction is based on neighboring DVs being highly spatially correlated, when the window is small, this assumption holds. When the window is big this does not hold. Accordingly, the prediction in the disparity estimation component preferably uses a big window with pixel selection, such as a 10×10 or larger. Only the pixels with similar RGB values as the center pixel's RGB values are selected because they more likely belong to the same object, and they more likely have the same disparities.

The overall block-diagram of the disparity map estimation 200 technique is illustrated in FIG. 3. There are several modules to the disparity map estimation.

Initially the left and right images are low pass filtered 201. Lowpass filtering is performed as a pre-processing step for two principal reasons. First, anti-alias filtering preparation for the following spatial down-sampling. Second, noise removal for increasing estimation stability. Any suitable lowpass filter may be used, such as for example, a Gaussian lowpass filter.

Next, spatial down-sampling of left and right images is performed 203. This down-samples both the image pairs, which reduces the computational cost in the following modules.

A prediction from the previous disparity vector map (“DVM”) 205 generates the prediction of the current disparity vector under search, DVₚ, from the DVM (disparity vector map) obtained in the previous layer. As previously discussed, DVₚ not only serves as the starting point of the search in the current layer, but also be used as a regularization term that penalizes the big deviation from DVₚ.

A cost function minimization 207 finds the disparity vectors by minimizing corresponding cost functions. As one embodiment, the technique uses a search to find the minimal value of the cost function

$$DV ( {x}_{0} ) = {argmin}_{DV} ( {ME}_{{x}_{0}} ( DV ) )$$

A spatial up-sampling of DVM 209 up-samples the DVM to the resolution of input images. Because the input images have been down-sampled in the spatial down-sampling module for reducing computational cost, the DVM calculated in the cost function minimization module only has the resolution of the down-sampled left image, which is lower than the original input images. Any suitable up-sampling technique may be used, such as bilinear interpolation.

The technique may be multilayer, which runs the above five modules multiple times with different parameters. By adjusting parameters in each layer, the multilayer structure tries to balance many contradictory requirements, such as computational cost, running speed, estimation accuracy, big/small objects, and estimation robustness. Specifically, in layer n, the following parameters may be re-set:

<1> the lowpass filtering parameter Lₙ used in block 201;

<2> the down-sampling and up-scaling factors Mₙ used in blocks 203 and 209;

<3> the window size 225 for calculating the prediction used in block 205;

<4> the window size 227 for block matching used in block 207;

<5> the search step 229 in block matching used in block 207; and

<6> the search range 231 in block matching used in block 207.

The disparity map adjustment 300 inputs LtoR and RtoL maps and corresponding matching errors (if desired), and outputs new disparity maps, LtoRₙ and RtoLₙ maps. The adjustment of disparity maps are based on two factors, namely, prediction of a model 302 and/or viewer preference 308.

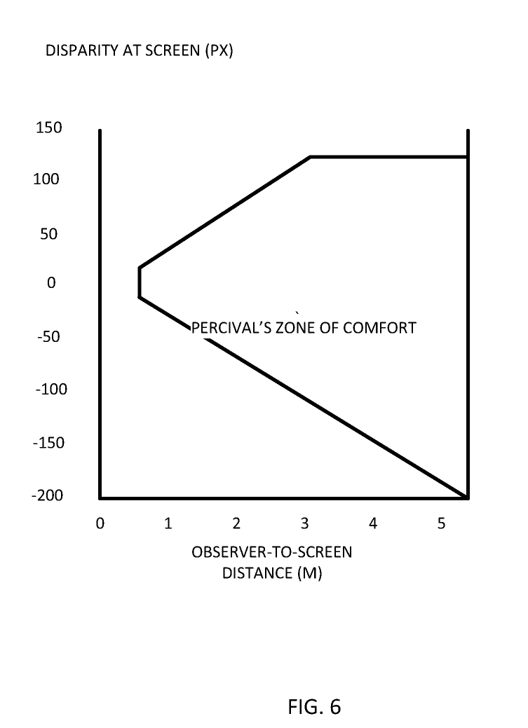

The model 302 is based on the human visual system's response to the stereoscopic stimulus, display characteristics, and/or viewing conditions. For example, the Percival's zone of comfort is graphically illustrated in FIG. 6 for a 46″ stereoscopic display with the 1920×1080 resolution.

The eye should be accommodated to a distance close to the object's focal distance for a stimulus to be properly focused on the retina of the viewer's eye. The typical depth of focus is ±0.3 diopters. For a set of images to be observed as a single image, rather than as a pair of separate images, the system should be converged to a distance close to that of the object distance. Vergence errors should be less than ±15-30 arc min which is generally the maximum disparity for which the visual system can fuse the two eyes' images and thereby produce a single perceived image.

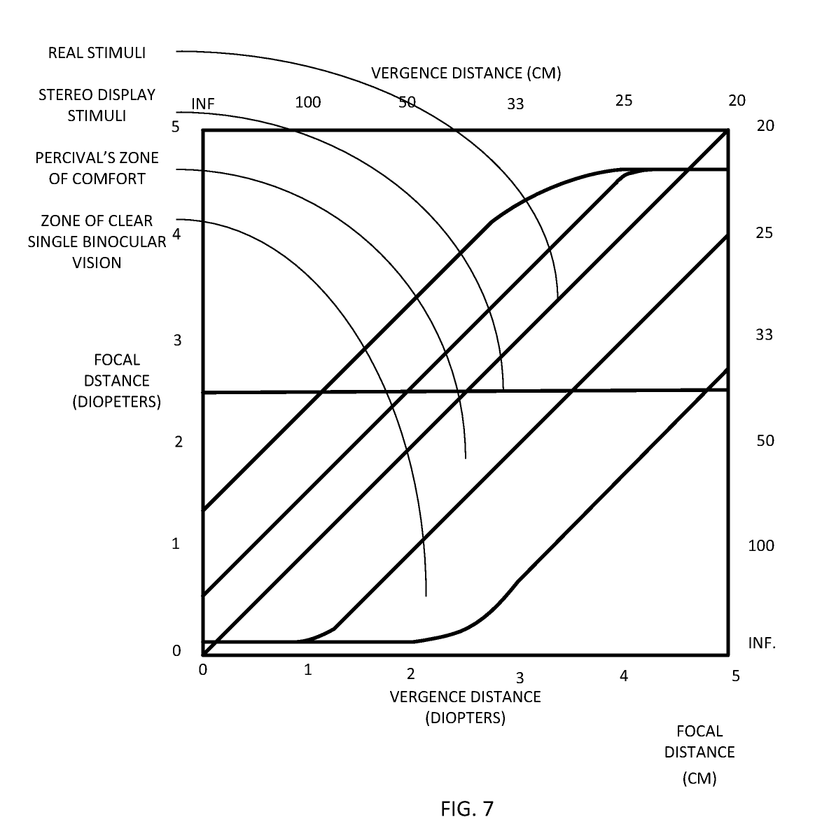

Referring also to FIG. 7, accommodation-vergence coupling is helpful because focal and vergence distances are almost always the same no matter where the viewer looks, as illustrated by the central diagonal line. The zone of clear single binocular vision is the set of vergence and focal distances for which a typical viewer can see a sharply focused single image; i.e., it is the set of those distances for which vergence and accommodation can be adjusted sufficiently well. Percival's zone of comfort is an optometric rule of thumb for the viewing of stereo stimuli; it is the approximate range of vergence and accommodation responses for which the viewer can fuse images without discomfort. As shown in FIG. 7, vergence and focal distance are close to one another to support clear, single vision without undue effort.

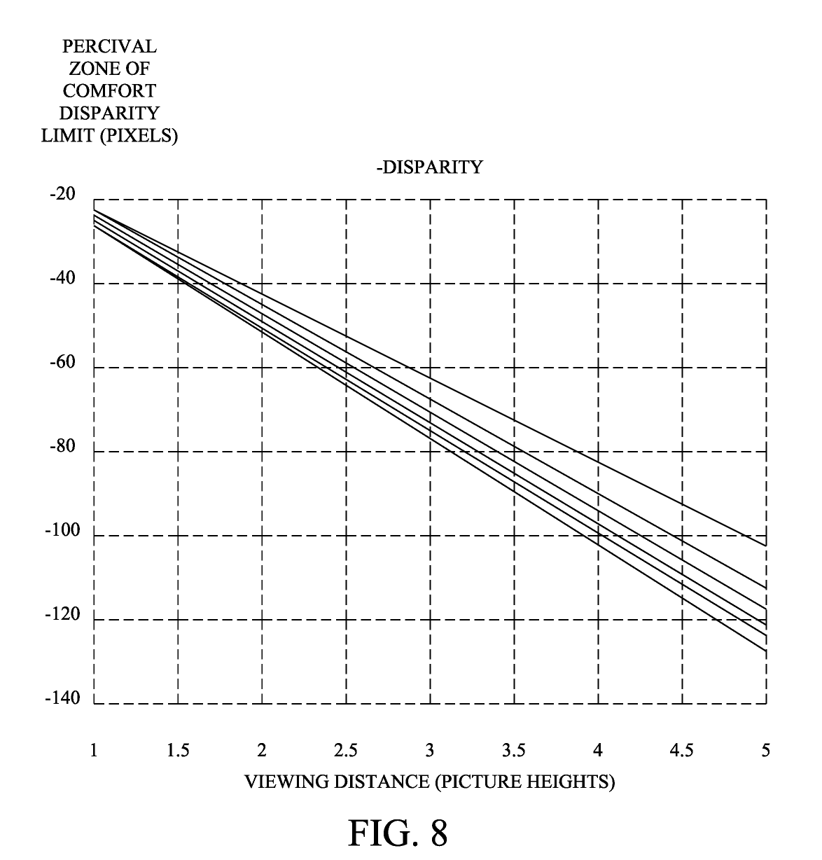

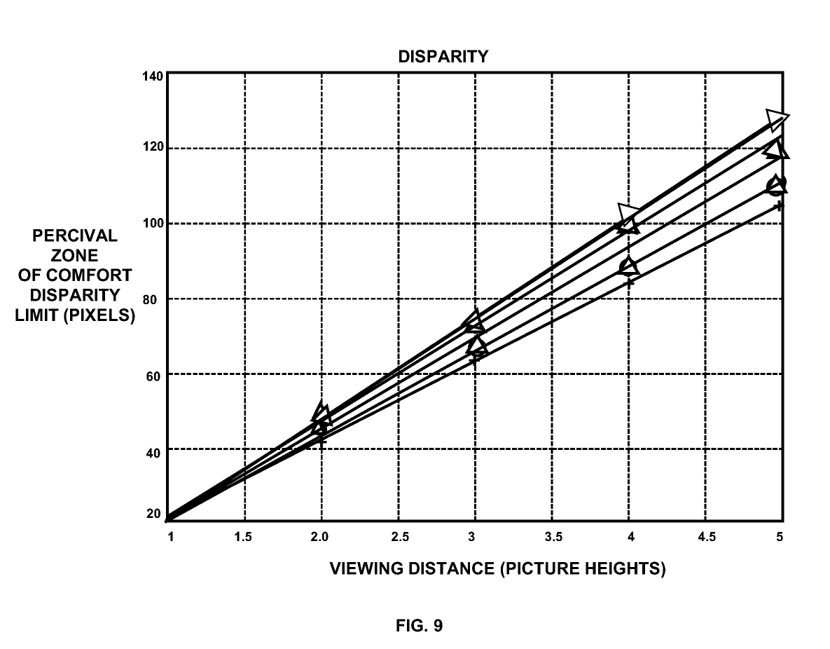

While the Percival's zone provides a suitable design for a particular viewing distance, its use results in a binary determination for all viewers as being either comfortable or uncomfortable. Referring to FIG. 8, a graph of viewing distance versus Percival Zone Of Comfort Disparity limit was determined for a group of 10 different viewers, for negative disparity. Referring to FIG. 9, a graph of viewing distance versus Percival Zone Of Comfort Disparity limit was determined for a group of 10 different viewers, for positive disparity. As it may be observed, each viewer has a different range of comfort and comfort disparity limit which is further dependent on the viewing distance. Among a number of different factors for each individual, the different inter pupil distances among the different viewers results in different comfort limits at different viewing distances.

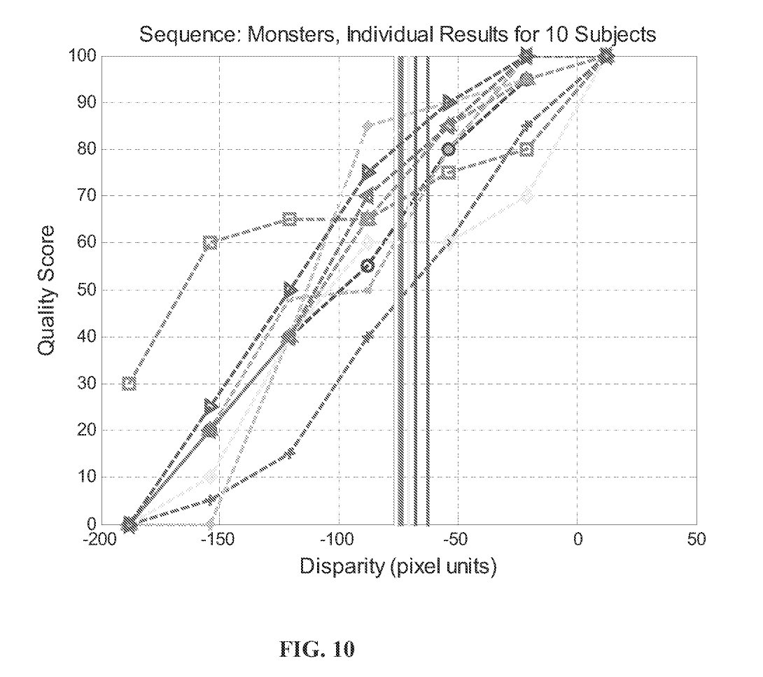

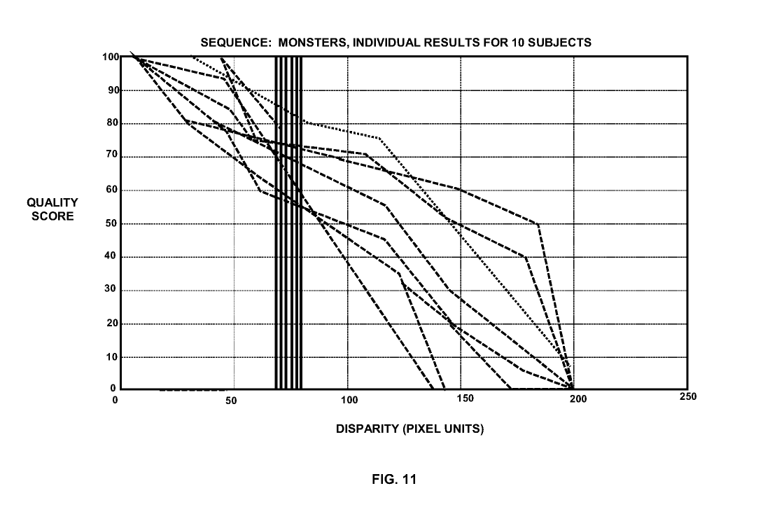

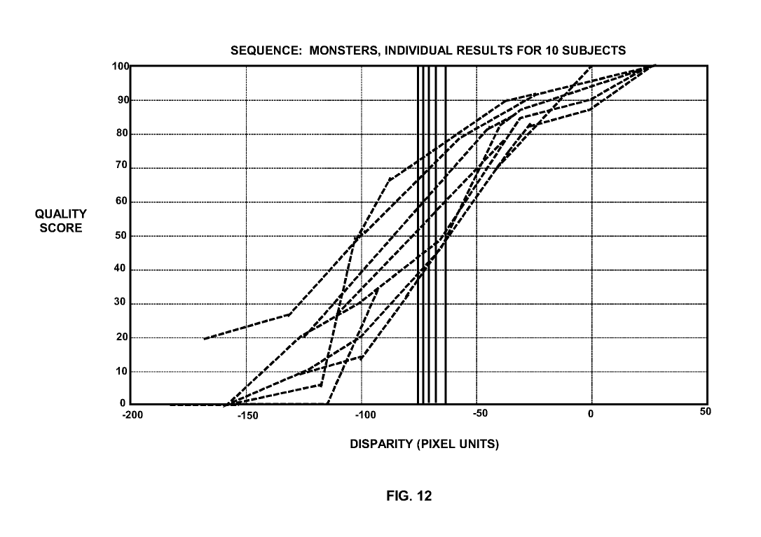

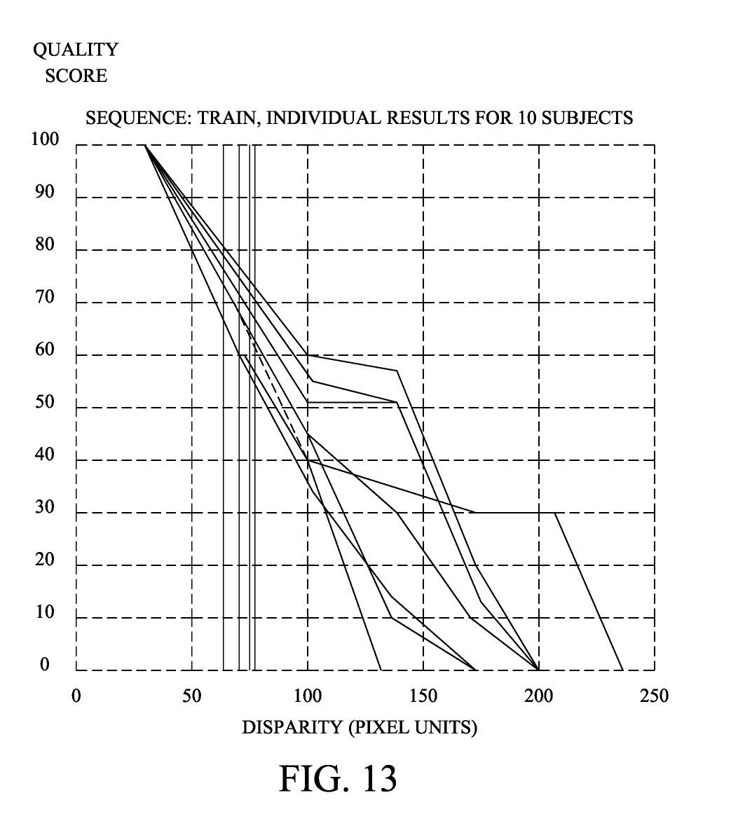

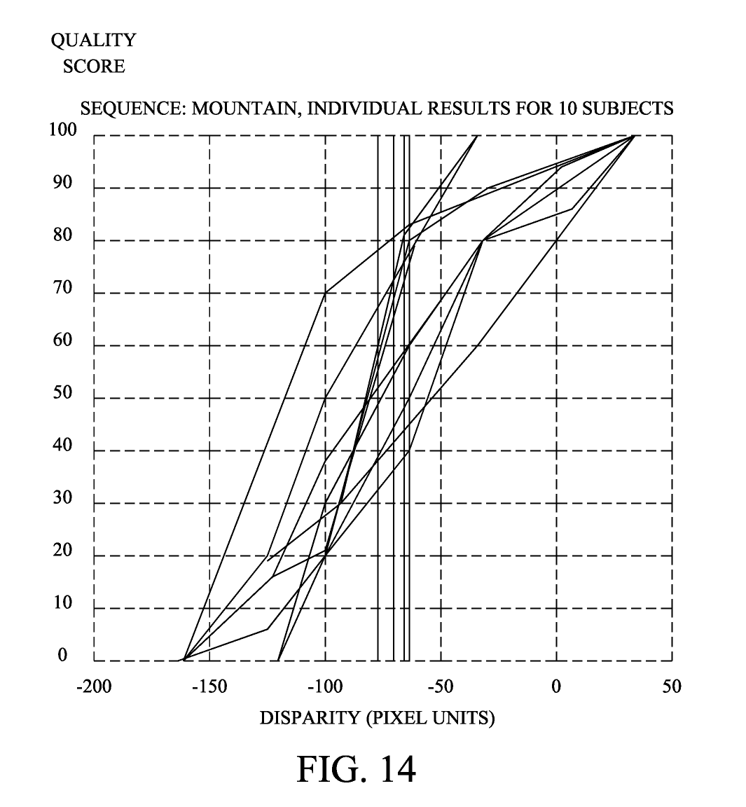

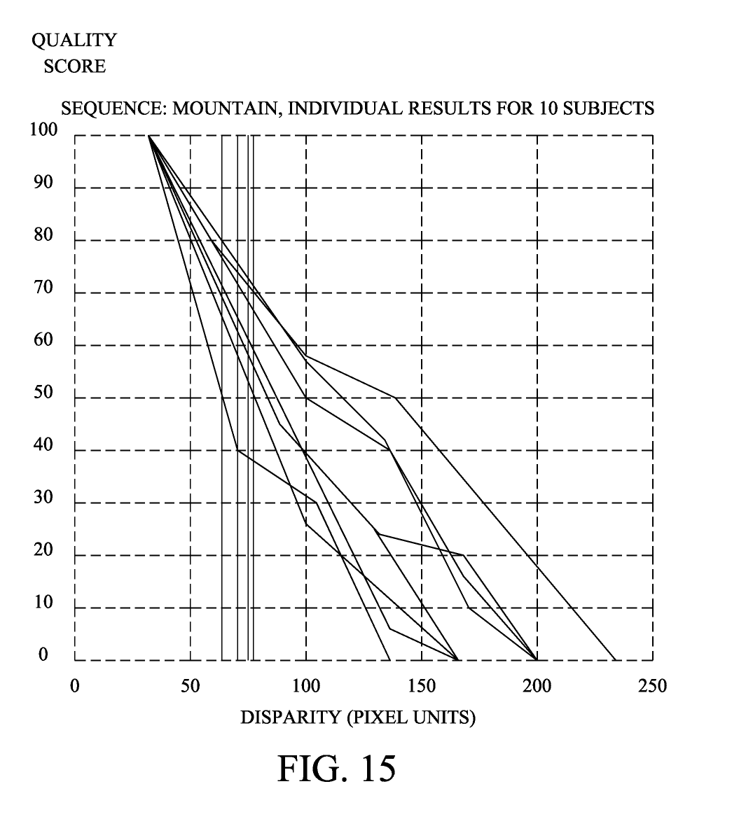

Referring to FIG. 10, FIG. 12, FIG. 14, without changing the native depth range of the stereoscopic image pairs, the disparity of the images were shifted to appear at different locations closer to the viewer in front of the display. Referring also to FIG. 11, FIG. 13, FIG. 15, without changing the native depth range of the stereoscopic image pairs, the disparity of the images were shifted to appear at different locations farther from the viewer behind the display. The disparity of the horizontal axis of FIG. 10 through FIG. 15 illustrates the average image disparity plus/minus the shift applied. It may be observed for different subjects, as the shift was increased the three dimensional viewing comfort for the viewers decreased. The central vertical lines represent the different individual Percival zone of comfort limits for the viewers. Again, it may be observed that the amount of disparity before a particular set of images becomes uncomfortable is viewer dependent.

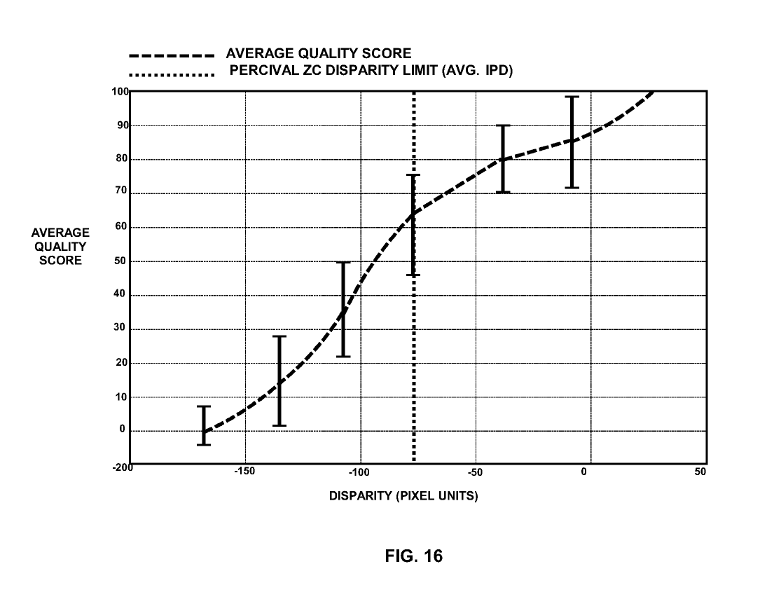

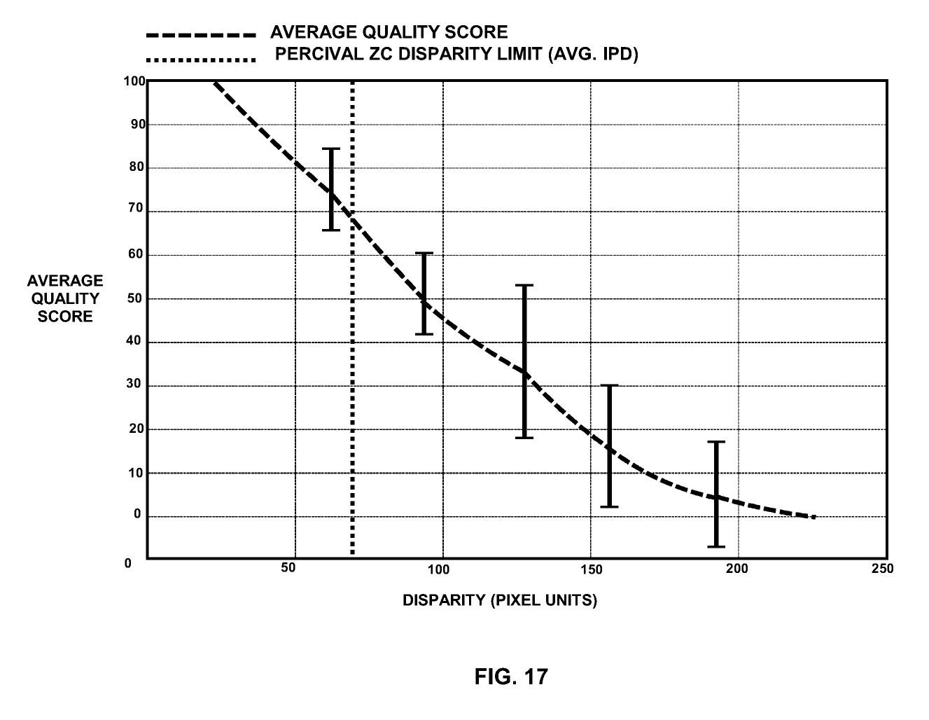

Referring to FIG. 16 and FIG. 17, the average quality score for all ten viewers for all three different images, are illustrated. The error bars show the 95% confidence interval. Also, the central vertical line shows the average of the ten viewer's individual Percival's zone of comfort disparity limit. It may be observed that the viewer perceived comfort can vary depending on the shift applied in a non-binary manner. For example, the comfort experienced for a particular shift for a particular set of images may be characterized as bad, poor, fair, good, and/or excellent. The quality labels bad, poof, fair, good, excellent may be defined as in ITU-R BT.500-11 recommendation, incorporated by reference herein. For example, the comfort experienced for a particular shirt for a particular set of images may be characterized as extreme (depth), mild (depth), and shallow (depth). In addition, the comfort experienced for a particular shift for a particular set of images may be dependent on the particular viewer.

The display system may include user selectable inputs which may be used to determine the acceptable range of positive and/or negative shifts or depth readjustment (e.g. depth scaling) which may be applied to the images. For example, if the value of 40 and above represents “fair” and fair is a suitable condition for a particular user, then a value of −100 negative disparity (see FIG. 16) and a value of +120 positive disparity (see FIG. 17) may be selected as the appropriate maximum range of values for the shifting to stay comfortable. Other values may likewise be selected based upon the user preferences. Moreover, the selected ranges may be dependent on the particular user based upon their preferences and/or user profile. The particular viewer preferences may be determined using any suitable technique, such as characterizing the viewer, the viewer using a series on on-screen tests, the viewer selecting a set of values, or user providing information about their Inter pupil distance or any other suitable manner.

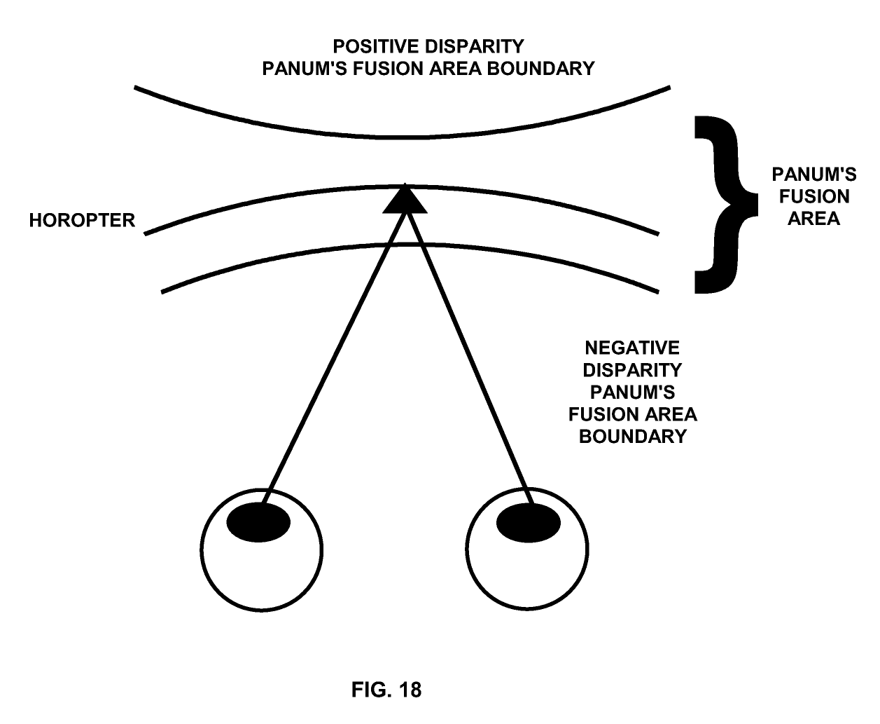

Referring to FIG. 18, there exists a limit to which the maximum disparity of the visual system can fuse the left and right images and thereby produce a single perceived 3D image. This limit is generally referred to as the positive disparity and negative disparity Panum's fusion area boundary, with the horopter being where the negative and positive disparities are the same.

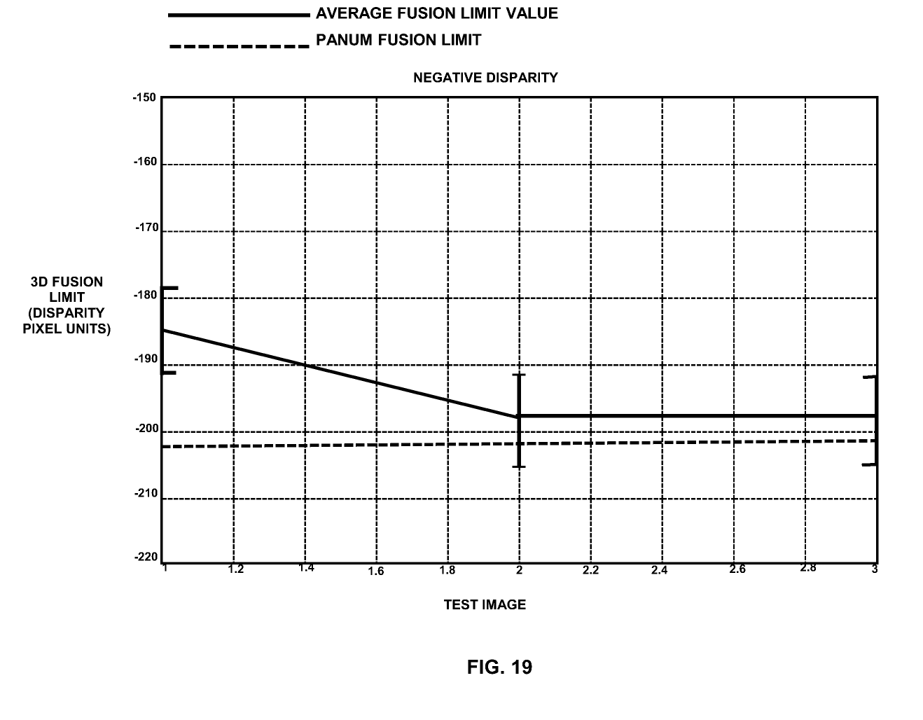

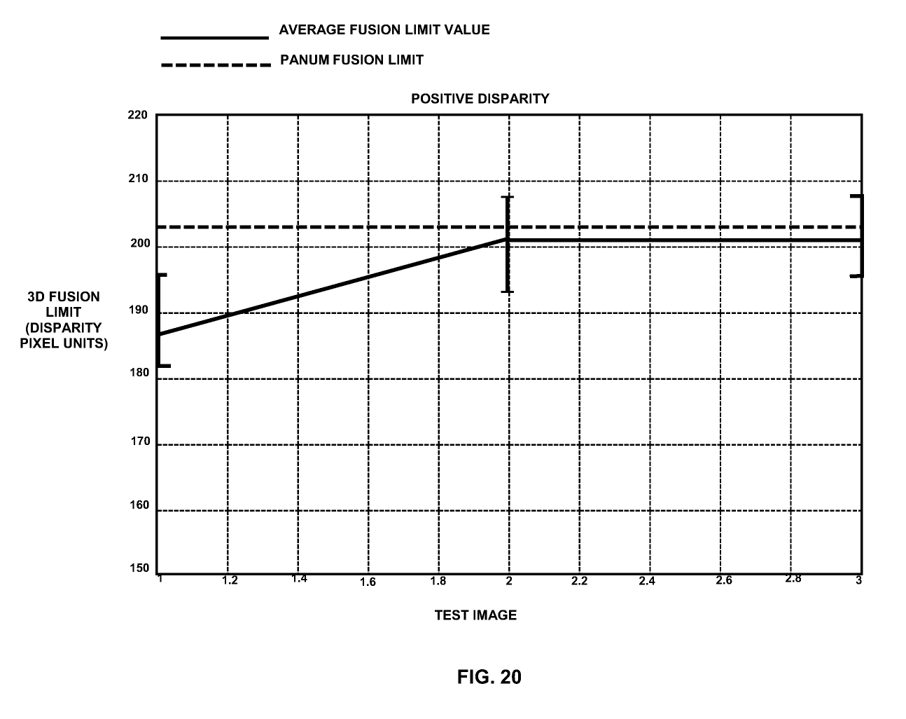

Referring to FIG. 19 (negative disparity) and FIG. 20 (positive disparity), the fusion area boundary tends to vary based upon the image content. In addition, the fusion area boundary also tends to vary based upon the particular viewer. The fusion area boundary may be used to set a maximum and/or minimum limit to the acceptable shifts or depth readjustment (e.g. depth scaling) for images. Accordingly, the selected range for the fusion area boundary may be viewer dependent.

The disparity map adjustment may adjust the output disparity maps to be within this Percival's zone of comfort. The adjustment may be done by scaling LtoRₙ=s*LtoR, and RtoLₙ=s*RtoL, where s is a scaling factor that is between 0 and 1.

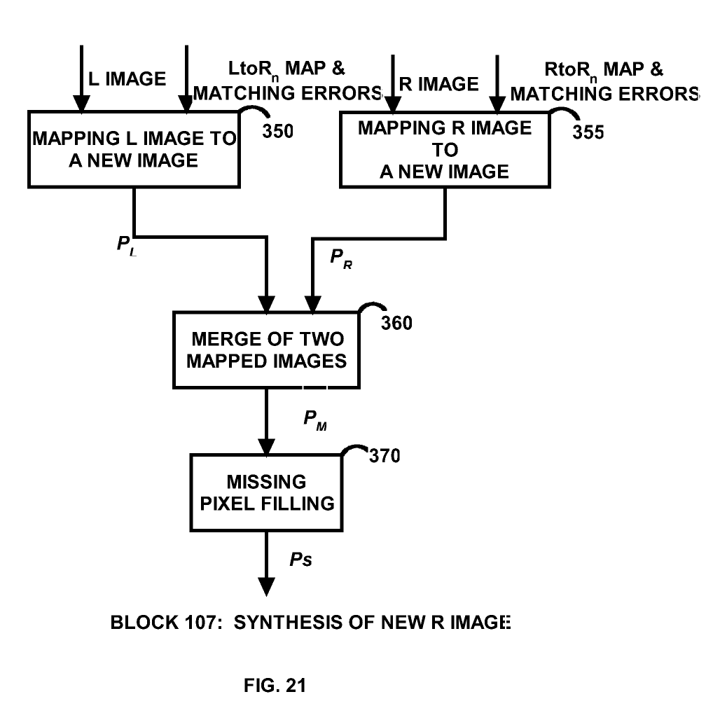

The new R image synthesis 400 includes inputs of: (1) the image pairs; (2) the new disparity maps; and (3) the disparity maps' matching errors, and determines the synthesized new R image. The block-diagram is shown in FIG. 21.

Referring to FIG. 21, two blocks, 350 and 355, map L and R images to two new images based on LtoRₙ and RtoLₙ maps, respectively. Specifically, block 350 conducts P_{L}(LtoRₙ(x))=L(x) if pixel at x is not a occluded pixel. Pixel at x of L image is mapped to the position at LtoRₙ(x) of the mapped image P_{L}. Similarly, block 355 conducts P_{R}(RtoLₙ(x))=R(x) if pixel at x is not a occluded pixel. Pixel at x of R image is mapped to the position at LtoRₙ(x) of the mapped image P_{R}.

The above mapping functions cannot guarantee that all pixels in F_{L} and P_{R} can be assigned a value. Inevitably, some pixels are missing in P_{L} and P_{R} due to either (1) occlusion, or (2) insufficient accuracy of disparity estimation plus quantization of space grids. Missing pixels caused by the former are clustered; while missing pixels caused by the latter are scattered. A pixel is an occluded pixel when this pixel appears only on one of the image pairs.

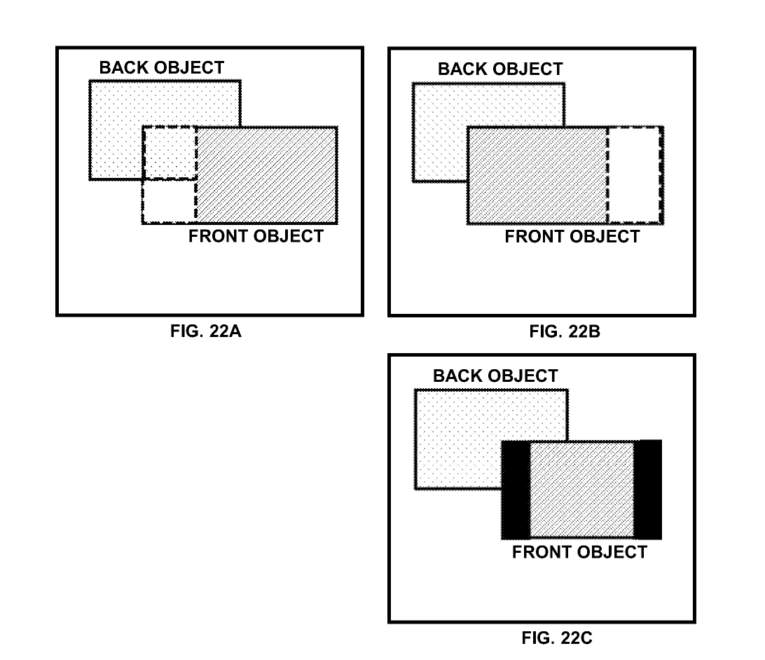

Referring to FIG. 22, two objects are shown having different depths; the front object occludes the back object and background, and occluded areas are marked with dashed boxes. An occluded pixel does not have a reliable disparity vector because there is no corresponding pixel in the other image. Specifically, in FIG. 22A there are no disparity vectors available for these pixels in part of the back object and part of background. In FIG. 22B there are no disparity vectors available for pixels in part of background. As a result, in FIG. 22C which is the synthesized new R image, there are two black regions, in which pixels cannot be determined from the stereoscopic pair and disparity maps. These undetermined pixels are determined by other means.

Blocks 350 and 355 should know if a pixel is an occluded pixel when conduct mapping. Occlusion detection is based the matching errors from the disparity estimation component block 200. If the matching error of a pixel is bigger than some threshold, then this pixel is labeled as occluded pixel and no mapping is done. Block 360 merges two images together to get a more reliable one, and also fill some missing pixels caused by insufficient accuracy of disparity estimation plus quantization of space grids. Specifically, for a position x of P_{L} and P_{R:}

if exist in both images, P_{M}(x)=(P_{L}(x)+P_{R}(x))/2;

if exist in P_{L}, P_{M}(x)=P_{L}(x);

if exist in P_{R}, P_{M}(x)=P_{R}(x);

if not exist in both images, P_{M}(x) is labeled as missing.

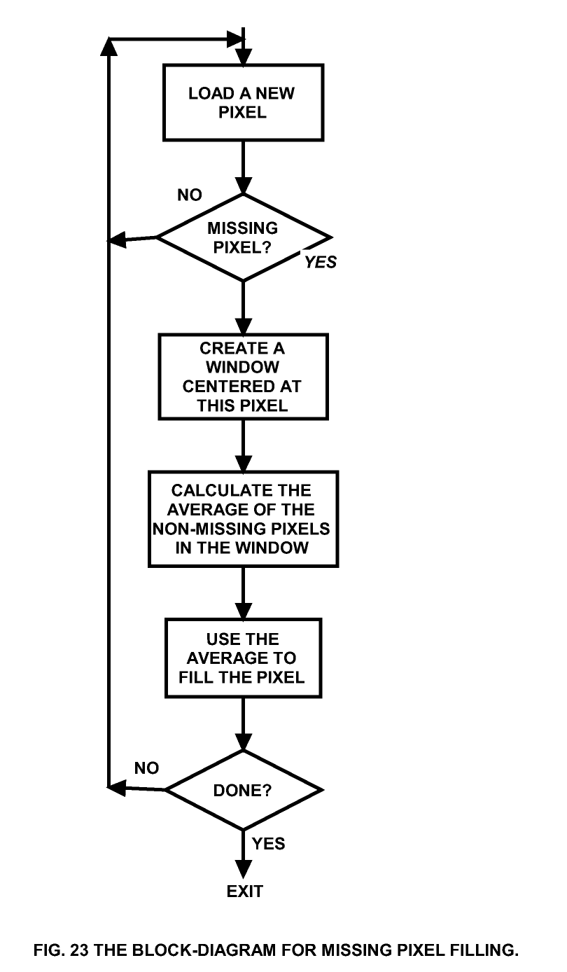

After merging, there are still some pixels left missing in P_{M}. In block 370, these missing pixels are filled with proper values. This technique is shown in FIG. 23.

The terms and expressions which have been employed in the foregoing specification are used therein as terms of description and not of limitation, and there is no intention, in the use of such terms and expressions, of excluding equivalents of the features shown and described or portions thereof, it being recognized that the scope of the invention is defined and limited only by the claims which follow.

I/We claim:

1. A method for displaying a pair of stereoscopic images on a display comprising:
(a) receiving a pair of images forming said pair of stereoscopic images, one being a left image and one being a right image;
(b) adjusting the disparity between said left image and said right image based upon a profile of a particular viewer.

2. The method of claim 1 where in said adjusting said disparity is based upon a non-binary determination of said particular viewer's comfort.

3. The method of claim 1 where in said adjusting said disparity said disparity has a positive disparity adjustment and a negative disparity adjustment, each of which has a different absolute value of said adjustment.

4. The method of claim 1 where in said adjusting said disparity is further based upon viewing distance to said display.

5. The method of claim 1 where in said adjusting is based upon a textual comfort range.

6. The method of claim 5 where in said textual comfort range includes at least one indicative of bad, poor, fair, good, and excellent.

7. The method of claim 1 where in said adjusting is based upon a numerical comfort range.

8. The method of claim 1 where in said adjusting said disparity is based upon said profile determined individually for said viewer.

9. The method of claim 1 where in said adjusting said disparity is based upon said profile determined based upon a series of on-screen tests.

10. The method of claim 1 where in said adjusting said disparity is based upon said profile determined based upon a set of values.

11. The method of claim 1 where in said adjusting said disparity is limited by a limit based upon the content of said image.

12. The method of claim 1 where in said adjusting said disparity is limited by said user profile.

13. The method of claim 1 where in said stereoscopic images include a horizontal disparity.

14. The method of claim 1 where in said profile is based upon an inter pupil distance.

15. The method of claim 1 where in said adjusting is based upon a depth preference.

16. The method of claim 15 where in said depth preference includes at least one indicative of extreme, mild, and shallow.

17. The method of claim 16 where in said extreme has a greater disparity adjustment than said mild, which has a greater disparity than said shallow.
